(19) United States
(12) Patent Application Publication
(10) Pub. No.: US 2024/0283030 A1
(43) Pub. Date: Aug. 22, 2024

(54) METHOD OF MANUFACTURING SOLID-STATE BATTERY, AND SOLID-STATE BATTERY

(71) Applicants: TOYOTA JIDOSHA KABUSHIKI KAISHA, Toyota-shi Aichi-ken (JP); Panasonic Holdings Corporation, Kadoma-shi Osaka (JP)

(72) Inventors: Sachie AKIBA, Toyota-shi Aichi-ken (JP); Akio KANEYAMA, Toyota-shi Aichi-ken (JP)

(73) Assignees: TOYOTA JIDOSHA KABUSHIKI KAISHA, Toyota-shi Aichi-ken (JP); Panasonic Holdings Corporation, Kadoma-shi Osaka (JP)

(21) Appl. No.: 18/442,720

(22) Filed: Feb. 15, 2024

(30) Foreign Application Priority Data
Feb. 16, 2023 (JP) 2023-022861

(51) Int. Cl. H01M 10/0585; H01M 4/62; H01M 10/0562

(52) U.S. Cl. CPC H01M 10/0585; H01M 4/621; H01M 10/0562; H01M 2300/0065

(57) ABSTRACT

The method of manufacturing a solid-state battery includes preparing a solid-state battery having an electrode body that has a positive electrode layer, a solid electrolyte layer, a negative electrode layer and an insulating layer and in which the positive electrode layer, the solid electrolyte layer and the negative electrode layer are layered in that order, and the insulating layer is disposed so as to contact a surface, which is at the positive electrode layer side, of the solid electrolyte layer in a layering direction, and so as to contact side surfaces of the positive electrode layer in a direction orthogonal to the layering direction and a longitudinal direction of the electrode body; and hot pressing the solid-state battery from both sides in the layering direction, wherein the insulating layer contains a first binder having a reaction force at a temperature of the hot pressing of from 0.60 N/mm² to 1.50 N/mm², and the positive electrode layer and the solid electrolyte layer contain a second binder having a reaction force at the temperature of the hot pressing of from 0.01 N/mm² to 0.40 N/mm².

### CROSS-REFERENCE TO RELATED APPLICATION

This application is based on and claims priority under 35 USC 119 from Japanese Patent Application No. 2023-022861 filed on Feb. 16, 2023, the disclosure of which is incorporated by reference herein.

### BACKGROUND

### Technical Field

The present disclosure relates to a method of manufacturing a solid-state battery and to a solid-state battery.

### Related Art

Solid-state batteries having an electrode body, in which a positive electrode layer, a solid electrolyte layer and a negative electrode layer are layered in that order, have conventionally been used.

For example, Japanese Patent Application Laid-Open No. 2022-104123 discloses a solid-state battery in which an insulating layer is disposed so as to contact a positive electrode layer, and specifically, discloses an all-solid-state battery including an electrode body in which a positive electrode collector foil, a positive electrode layer, a solid electrolyte layer, a negative electrode layer and a negative electrode collector foil are layered in that order, wherein the insulating layer is disposed on the surface, which is at the positive electrode layer side, of the positive electrode collector foil at a portion facing at least the solid electrolyte layer and an end portion of the negative electrode layer.

### SUMMARY

In a solid-state battery having an electrode body in which a positive electrode layer, a solid electrolyte layer and a negative electrode layer are layered in that order and in which, moreover, an insulating layer is disposed so as to contact a side surface of the positive electrode layer in the direction orthogonal to the layering direction and the longitudinal direction of the electrode body, when hot pressing is carried out from both sides in the layering direction in the manufacturing process, there is the concern that peeling of the insulating layer will occur.

The present disclosure was made in view of the above-described circumstances, and objects thereof are to provide a method of manufacturing a solid-state battery in which peeling of an insulating layer at the time of hot pressing is suppressed, and to provide a solid-state battery at which peeling of an insulating layer is suppressed.

A method of manufacturing a solid-state battery of a first aspect of the present disclosure, including:
preparing a solid-state battery having an electrode body that has a positive electrode layer, a solid electrolyte layer, a negative electrode layer and an insulating layer and in which the positive electrode layer, the solid electrolyte layer and the negative electrode layer are layered in that order, and the insulating layer is disposed so as to contact a surface, which is at the positive electrode layer side of the solid electrolyte layer in a layering direction, and so as to contact side surfaces of the positive electrode layer in a direction orthogonal to the layering direction and a longitudinal direction of the electrode body; and
hot pressing the solid-state battery from both sides in the layering direction,
wherein the insulating layer contains a first binder having a reaction force at a temperature of the hot pressing of from 0.60 N/mm² to 1.50 N/mm², and
the positive electrode layer and the solid electrolyte layer contain a second binder having a reaction force at the temperature of the hot pressing of from 0.01 N/mm² to 0.40 N/mm².

A method of manufacturing a solid-state battery of a second aspect according to the present disclosure is the method of manufacturing a solid-state battery of the first aspect, wherein the reaction force of the first binder at the temperature of the hot pressing is 5 or more times the reaction force of the second binder at the temperature of the hot pressing.

A method of manufacturing a solid-state battery of a third aspect according to the present disclosure is the method of manufacturing a solid-state battery of the first aspect or the second aspect, wherein the first binder is a block copolymer of styrene-ethylene/butylene-styrene, and the second binder is styrene-butadiene rubber.

A method of manufacturing a solid-state battery of a fourth aspect according to the present disclosure is the method of manufacturing a solid-state battery of any one of the first aspect to the third aspect, wherein a filling rate of the insulating layer after the hot pressing is from 70% to 80%.

A solid-state battery of a fifth aspect of the present disclosure including:
an electrode body having a positive electrode layer, a solid electrolyte layer, a negative electrode layer and an insulating layer,
wherein:
the positive electrode layer, the solid electrolyte layer and the negative electrode layer are layered in that order,
the insulating layer is disposed so as to contact a surface, which is at the positive electrode layer side of the solid electrolyte layer in a layering direction, and so as to contact side surfaces of the positive electrode layer in a direction orthogonal to the layering direction and a longitudinal direction of the electrode body,
the insulating layer contains a first binder having a reaction force at 120° C. of from 1.00 N/mm² to 1.50 N/mm², and
the positive electrode layer and the solid electrolyte layer contain a second binder having a reaction force at 120° C. of from 0.01 N/mm² to 0.40 N/mm².

In accordance with the present disclosure, there can be provided a method of manufacturing a solid-state battery in which peeling of an insulating layer at the time of hot pressing is suppressed, and a solid-state battery at which peeling of an insulating layer is suppressed.

### BRIEF DESCRIPTION OF THE DRAWINGS

FIG. 1 is a schematic top view illustrating the structure of a solid-state battery relating to an embodiment of the present disclosure;

FIG. 2 is a schematic sectional view of the X-X cross-section of FIG. 1; and

FIG. 3 is a schematic top view illustrating the structure of a solid-state battery relating to another embodiment of the present disclosure.

### DETAILED DESCRIPTION

A method of manufacturing a solid-state battery and a solid-state battery of the present disclosure are described in detail hereinafter by using the drawings. The respective drawings described hereinafter are schematic illustrations, and sizes and shapes of respective portions are exaggerated when appropriate in order to facilitate understanding.

### <Method of Manufacturing Solid-State Battery>

### —Preparing Solid-State Battery Having Electrode Body—

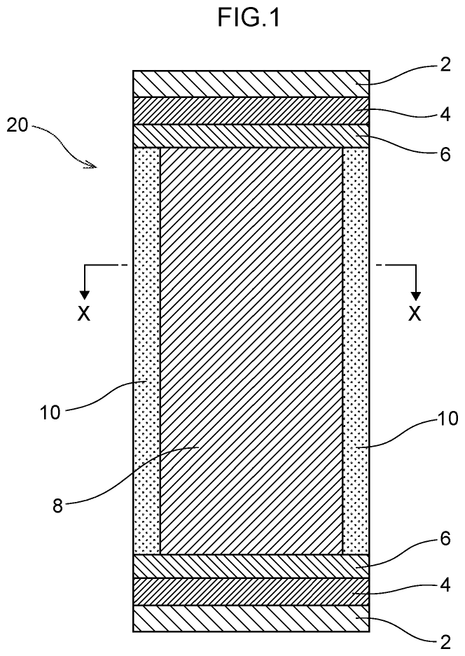

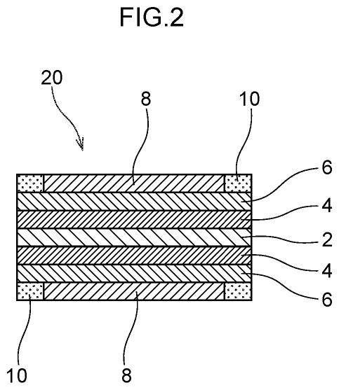

FIG. 1 is a schematic top view illustrating the structure of a solid-state battery relating to an embodiment of the present disclosure. FIG. 2 is a schematic sectional view of the X-X cross-section of FIG. 1. The solid-state battery illustrated in FIG. 1 and FIG. 2 is a solid-state battery 20 at which a total of two electrode bodies are disposed as a pair, with one at each of the both surfaces of a collector 2. The solid-state battery 20 has a structure in which a negative electrode layer 4, a solid electrolyte layer 6 and a positive electrode layer 8 are layered in that order from the collector 2 side at each of the both surfaces of the collector 2. Further, the solid-state battery 20 has a structure in which two insulating layers 10 are disposed so as to contact the surface, which is at the positive electrode layer 8 side, of the solid electrolyte layer 6 in the layering direction, and so as to contact the side surfaces at both sides of the positive electrode layer 8 in the direction orthogonal to the layering direction (i.e., the up-down direction in FIG. 2) and the longitudinal direction of the electrode body (i.e., the up-down direction in FIG. 1). (Namely, the orthogonal direction is the left-right direction in FIG. 1 and the left-right direction in FIG. 2, and there are four of the insulating layers 10 at the solid-state battery 20 on the whole.) Each one electrode body is structured by the negative electrode layer 4, the solid electrolyte layer 6, the positive electrode layer 8, and the two insulating layers 10 that are disposed at the both side surfaces of the positive electrode layer 8. In other words, at the solid-state battery 20, a total of two electrode bodies are disposed as a pair, with one being at each of the both surfaces of the collector 2.

Note that the solid-state battery in the Preparing contains binders in the insulating layer, the positive electrode layer and the solid electrolyte layer. The insulating layer contains a first binder having a reaction force at the temperature in the hot pressing of from 0.60 N/mm² to 1.50 N/mm², and the positive electrode layer and the solid electrolyte layer contain a second binder having a reaction force at the temperature in the hot pressing of from 0.01 N/mm² to 0.40 N/mm².

### —Hot Pressing—

In the hot pressing, the solid-state battery 20 is hot pressed from the both sides in the layering direction (i.e., the up-down direction in FIG. 2). An example of the method of hot pressing is a method in which the solid-state battery 20 is passed through between a pair of rollers that rotate in a forward direction (i.e., a roller pair formed from two rollers that rotate opposite one another), and heat and pressure are applied to the solid-state battery 20 from the rollers.

The solid-state battery relating to the embodiment of the present disclosure has the effect of suppressing peeling of the insulating layers at the time of hot pressing. Reasons why this effect is achieved are assumed to be as follows.

Conventionally, in a solid-state battery having an electrode body in which a positive electrode layer, a solid electrolyte layer and a negative electrode layer are layered in that order, insulating layers are disposed so as to contact the side surfaces of the positive electrode layer in the direction orthogonal to the layering direction and the longitudinal direction of the electrode body, from the standpoint of suppressing short-circuiting that occurs at the positive electrode layer. However, when hot pressing is carried out from both sides in the layering direction in the manufacturing process on the solid-state battery at which insulating layers are disposed at the side surfaces of the positive electrode layer, there are cases in which peeling of the insulating layers occurs. The reason why peeling of the insulating layers occurs is thought to be that the binder contained in the insulating layers seeps-out in the high-temperature environment at the time of the hot pressing and adheres to the hot pressing members (e.g., the rollers for hot pressing), and peeling of the insulating layers occurs due to the effect of the binder that has that has adhered to the hot pressing members.

In contrast, in the solid-state battery relating to the embodiment of the present disclosure, a first binder, having a reaction force at the temperature in the hot pressing of from 0.60 N/mm² to 1.50 N/mm², is contained in the insulating layers, and a second binder, having a reaction force at the temperature in the hot pressing of from 0.01 N/mm² to 0.40 N/mm², is contained in the positive electrode layer and the solid electrolyte layer. Therefore, the first binder, which has high reaction force even in a high-temperature environment such as that which is imparted at the time of hot pressing, is contained in the insulating layers, and seepage of the binder from within the insulating layers at the time of hot pressing is suppressed. As a result, adhesion of the binder to the hot pressing members is reduced, and peeling of the insulating layers is suppressed. Further, the second binder that has low reaction force in a high-temperature environment is contained, i.e., a binder having a strong binding force is contained, in the positive electrode layer and the solid electrolyte layer. Therefore, a good binding ability between the positive electrode layer and the insulating layers, and between the solid electrolyte layer and the insulating layers, and between the positive electrode layer and the solid electrolyte layer, is realized.

Note that the reason why a large amount of the binder does not adhere to the hot pressing members from the positive electrode layer at the time of hot pressing even if the binder that is contained in the positive electrode layer is the second binder that has low reaction force in a high-temperature environment, is thought to be as follows. Namely, the positive electrode layer is disposed at the central sides with respect to the insulating layers (e.g., at the central side in the left-right direction in FIG. 1 and FIG. 2), and, at the time when pressure is applied from the hot pressing members, there is a strong tendency for the binder to flow toward the sides of the side surfaces of the positive electrode layer (e.g., the left-right direction in FIG. 1 and FIG. 2), and it is difficult for the binder to seep-out to the hot pressing member side.

### (Binders)

### Reaction Force

The solid-state battery in the preparing contains, in the insulating layers, the first binder whose reaction force at the temperature of the hot pressing is 0.60 N/mm²˜1.50 N/mm². In some embodiments, the reaction force of the first binder at the hot pressing temperature is 0.70 N/mm²˜1.30 N/mm², or 0.80 N/mm²˜1.20 N/mm². Due to the reaction force of the first binder at the temperature of the hot pressing being greater than or equal to the aforementioned lower limit value, seeping-out of the binder from within the insulating layers at the time of hot pressing is suppressed, and peeling of the insulating layers is suppressed. Due to the reaction force of the first binder at the temperature of the hot pressing being less than or equal to the aforementioned upper limit value, a good binding ability between the insulating layers and the respective layers that contact the insulating layers is realized.

The positive electrode layer and the solid electrolyte layer contain the second binder whose reaction force at the temperature in the hot pressing is 0.01 N/mm²˜0.40 N/mm². In some embodiments, the reaction force of the second binder at the hot pressing temperature is 0.02 N/mm²˜0.30 N/mm², or 0.03 N/mm²˜0.25 N/mm². Due to the reaction force of the second binder at the temperature of the hot pressing being greater than or equal to the aforementioned lower limit value, the binder does not melt excessively even in the high-temperature environment at the time of hot pressing, and the binding ability in a high-temperature environment is maintained. Due to the reaction force of the second binder at the temperature of the hot pressing being less than or equal to the aforementioned upper limit value, good binding ability between the positive electrode layer and the insulating layers, and between the solid electrolyte layer and the insulating layers, and between the positive electrode layer and the solid electrolyte layer, is realized.

### Ratio of Reaction Forces

In some embodiments, the reaction force of the first binder at the temperature of the hot pressing is 5 times or more the reaction force of the second binder at the temperature of the hot pressing. In some embodiments, the ratio of the reaction forces, at the temperature of the hot pressing, of the first binder and the second binder (first binder/second binder) is 8 times or more, or 10 times or more. Due to the ratio of the reaction forces, at the temperature of the hot pressing, of the first binder and the second binder (first binder/second binder) being in the above-described range, peeling of the insulating layers at the time of hot pressing is suppressed, and good binding ability between the positive electrode layer and the insulating layers, and between the solid electrolyte layer and the insulating layers, and between the positive electrode layer and the solid electrolyte layer, is realized.

### Measuring of Reaction Forces

The reaction forces of the first binder that is contained in the insulating layers and the second binder that is contained in the positive electrode layer and the solid electrolyte layer are measured by the following method. Pressure and heat are applied from the vertical directions to a measurement sample of the binder until the thickness of the measurement sample decreases by 25%, and thereafter, the measurement sample is left for 10,000 minutes, and the changes over time in the reaction force from the measurement sample are measured. Note that the measurement sample of the binder is a sample that is formed from only the binder that is the object of measurement, and the size thereof is q 20 mm and a thickness of 5 mm. The TENSILON universal tester, model RTC-1350A, manufactured by A&D Company, Ltd. (having a tank for high-temperature measurement (TKC) and at which measurement up to 270° C. is possible) is used in measuring the reaction force. The load is set to the compression mode and is held for the aforementioned time at a height at which the sample thickness is 3.75 mm, and the value from a load cell at that time is recorded as the reaction force. Note that the measurement temperature is set to the highest allowable temperature at the time of hot pressing in a case of measuring the “reaction force at the temperature of hot pressing”, and is set to 120° C. in a case of measuring the “reaction force at 120° C.”, and measurement is carried out in an environment in which the entire device is at the set temperature. The average value of 10 seconds˜20 seconds is calculated from the obtained changes over time in the reaction force, and this is used as the reaction force.

### Types of Binders

From the standpoint of keeping the reaction force in the above-described range, examples of the first binder that is contained in the insulating layers are a block copolymer (SEBS) of styrene-ethylene/butylene-styrene, a block copolymer (SEPS) of styrene-ethylene/propylene-styrene, a block copolymer (SEEPS) of styrene-ethylene/ethylene/propylene-styrene, a block copolymer (SBS) of styrene-butadiene-styrene, and a block copolymer (SIS) of styrene-isoprene-styrene. In some embodiments, thereamong, styrene-ethylene/butylene-styrene block copolymer is selected.

From the standpoint of keeping the reaction force in the above-described range, examples of the second binder that is contained in the positive electrode layer and the solid electrolyte layer are elastomers that are not block copolymers such as styrene-butadiene rubber (SBR), PVdF, BR, NBR and the like, and acrylic resins such as PMMA and the like. In some embodiments, thereamong, styrene-butadiene rubber is selected.

### Content of Binders

In some embodiments, the content of the first binder in the insulating layer, with respect to the entire insulating layer, is 2 mass %˜6 mass %, or 3 mass %˜5 mass %. Due to the content of the first binder in the insulating layer being greater than or equal to the aforementioned lower limit value, a good binding ability between the insulating layers and the respective layers that contact the insulating layers is realized. Due to the content of the first binder in the insulating layers being less than or equal to the aforementioned upper limit value, seeping-out of the binder from within the insulating layers at the time of hot pressing is suppressed, and peeling of the insulating layers is suppressed.

In some embodiments, the content of the second binder in the positive electrode layer and the solid electrolyte layer, with respect to the entire positive electrode layer and the entire solid electrolyte layer, is 0.5 mass %˜3 mass %, or 1 mass %˜2 mass %. Due to the content of the second binder in the positive electrode layer and the solid electrolyte layer being greater than or equal to the aforementioned lower limit value, a good binding ability between the positive electrode layer and the insulating layers, and between the solid electrolyte layer and the insulating layers, and between the positive electrode layer and the solid electrolyte layer, is realized. Due to the content of the second binder in the positive electrode layer and the solid electrolyte layer being less than or equal to the aforementioned upper limit value, it is easy to maintain the performances, other than the binding ability, that are required of the positive electrode layer and the solid electrolyte layer.

### (Other Conditions)

### Temperature of Hot Pressing

In some embodiments, the temperature of the hot pressing in the hot pressing, i.e., the highest allowable temperature at the time of hot pressing, is 110° C.˜180° C., or 120° C.˜170° C. Due to the temperature of the hot pressing being greater than or equal to the aforementioned lower limit value, good binding ability of the respective layers is realized. Due to the temperature of the hot pressing being less than or equal to the aforementioned upper limit value, seeping-out of the binder from within the insulating layers at the time of hot pressing is suppressed, and peeling of the insulating layers is suppressed. Note that the temperature of the hot pressing means the maximum allowable temperature at the time of hot pressing, at the surface of the hot pressing member (e.g., rollers for hot pressing).

### Filling Rate of Insulating Layer

In some embodiments, the filling rate of the insulating layer after having undergone the hot pressing is 70%˜80%, or 72%˜78%. Due to the filling rate of the insulating layer being greater than or equal to the aforementioned lower limit value, the occurrence of peeling at the insulating layers is suppressed. Due to the filling rate of the insulating layer being less than or equal to the aforementioned upper limit value, the occurrence of defects at the end portions (i.e., the side surfaces) of the insulating layers, e.g., the occurrence of tearing at the end portions, is suppressed. Note that the filling rate of the insulating layer means the proportion of regions other than voids in the insulating layer.

The filling rate of the insulating layer is measured by the following method. The mass of the insulating layer is measured at a predetermined surface area by using a punching electronic balance. Further, the thickness of the insulating layer is measured from an image of a cut cross-section by using a microscope (VHX series manufactured by Keyence Corporation). The filling rate of the insulating layer is calculated from the results of measurement of the mass and the thickness.

### Modified Example

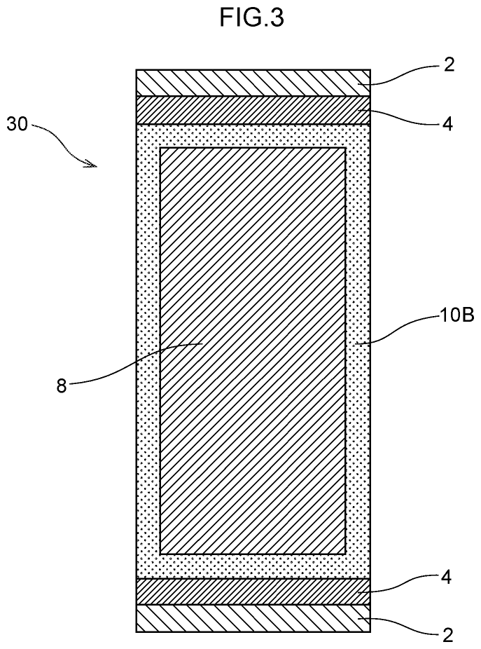

FIG. 1 and FIG. 2 illustrate a structure in which the insulating layer at the electrode body is the two insulating layers 10 that are disposed so as to contact the both side surfaces of the positive electrode layer 8 in the direction orthogonal to the layering direction and the longitudinal direction of the electrode body. However, the present disclosure not limited to the same. For example, as illustrated in FIG. 3, a solid-state battery 30 has an insulating layer 10B may be disposed so as to, in addition to the side surfaces at the both sides of the positive electrode layer 8 in the direction orthogonal to the layering direction and the longitudinal direction of the electrode body, also contact the side surfaces at the both sides of the positive electrode layer 8 in the longitudinal direction of the electrode body (i.e., the up-down direction in FIG. 1). Namely, there may be a structure in which the one insulating layer 10B is disposed so as to surround the side surfaces of the positive electrode layer 8.

### <Solid-State Battery>

The solid-state battery relating to the embodiment of the present disclosure includes a positive electrode layer, a solid electrolyte layer, a negative electrode layer and an insulating layer. The positive electrode layer, the solid electrolyte layer and the negative electrode layer are layered in that order. The insulating layer is disposed so as to contact the surface, which is at the positive electrode layer side, of the solid electrolyte layer in the layering direction, and so as to contact the side surfaces of the positive electrode layer in the direction orthogonal to the layering direction and the longitudinal direction of the electrode body. The insulating layer contains a first binder having a reaction force at 120° C. of from 1.00 N/mm² to 1.50 N/mm², and the positive electrode layer and the solid electrolyte layer contain a second binder having a reaction force at 120° C. of from 0.01 N/mm² to 0.40 N/mm².

### Reaction Force

The solid-state battery contains binders in the insulating layer, the positive electrode layer and the solid electrolyte layer. The insulating layer contains a first binder whose reaction force at 120° C. is 1.00 N/mm²˜1.50 N/mm². In some embodiments, the reaction force of the first binder at 120° C. is 1.05 N/mm²˜1.30 N/mm², or 1.10 N/mm²˜1.20 N/mm². Due to the reaction force of the first binder at 120° C. being greater than or equal to the aforementioned lower limit value, peeling of the insulating layer at the time of hot pressing is suppressed, and, as a result, the binding force of the insulating layer is maintained good. Due to the reaction force of the first binder at the insulating layer being less than or equal to the aforementioned upper limit value, a good binding ability between the insulating layer and the respective layers that contact the insulating layer is realized.

The positive electrode layer and the solid electrolyte layer contain a second binder whose reaction force at 120° C. is 0.01 N/mm²˜0.40 N/mm². In some embodiments, the reaction force of the second binder at 120° C. is 0.02 N/mm²˜0.30 N/mm², or 0.03 N/mm²˜ 0.25 N/mm². Due to the reaction force of the second binder at 120° C. being greater than or equal to the aforementioned lower limit value, the binder does not melt excessively even in the high-temperature environment of the time of the hot pressing, and the binding ability in a high-temperature environment is maintained, and as a result, the binding forces of the positive electrode layer and the solid electrolyte layer are maintained good. Due to the reaction force of the second binder at 120° C. being less than or equal to the aforementioned upper limit value, a good binding ability between the positive electrode layer and the insulating layer, and between the solid electrolyte layer and the insulating layer, and between the positive electrode layer and the solid electrolyte layer, is realized.

### Insulating Layer, Positive Electrode Layer, Negative Electrode Layer, Solid

### Electrolyte Layer

The insulating layer contains, for example, an insulating material and a binder. The above-described binders that are exemplified as the first binder are suitable examples of the binder. Examples of the insulating material are solid electrolytes. The solid electrolytes in the solid electrolyte layer that are described hereinafter are examples of the solid electrolytes.

The positive electrode layer contains at least a positive electrode active material. The positive electrode layer may further contain at least one of a conductive material, an electrolyte and a binder.

The negative electrode layer contains at least a negative electrode active material. The negative electrode layer may further contain at least one of a conductive material, an electrolyte and a binder.

The solid electrolyte layer is disposed between the positive electrode layer and the negative electrode layer, and contains at least a solid electrolyte. In some embodiments, the solid electrolyte includes at least one type of solid electrolyte selected from the group of solid electrolytes consisting of sulfide solid electrolytes, oxide solid electrolytes and halide solid electrolytes.

The present disclosure is not limited to the above-described embodiments. The above embodiments are illustrative, and all forms that have substantially the same structures as, and exhibit similar operations and effects as, the technical concepts put forth in the claims of the present disclosure are included in the technical scope of the present disclosure.

### EXAMPLES

The effects of the solid-state battery relating to the present disclosure were confirmed by experimentation.

### Examples 1˜9, Comparative Examples 1˜6

First, in the same way as the structure illustrated in FIG. 1, the solid-state battery 20 was prepared in which a total of two electrode bodies were disposed as a pair, with one being at each of the both surfaces of the collector 2. The solid-state battery 20 had, at each of the both surfaces of the collector 2, a structure in which the negative electrode layer 4, the solid electrolyte layer 6 and the positive electrode layer 8 were layered in that order from the collector 2 side. Further, the solid-state battery 20 had a structure in which the two insulating layers 10 were disposed so as to contact the surface, which was at the positive electrode layer 8 side, of the solid electrolyte layer 6 in the layering direction, and so as to contact the side surfaces at the both sides of the positive electrode layer 8 in the direction orthogonal to the layering direction and the longitudinal direction of the electrode body.

The respective compositions of the positive electrode layer, the solid electrolyte layer, the negative electrode layer and the insulating layers were as follows.
positive electrode layer (proportion of solids 75%): active material: 74%, solid electrolyte: 23%, conduction assistant: 2.5%, binder: 0.5%
solid electrolyte layer (proportion of solids 50%): solid electrolyte: 97%, binder: 3%
negative electrode layer (proportion of solids 60%): active material: 74%, SE: 25%, binder: 1%
insulating layer (proportion of solids 55%): solid electrolyte: 96%, binder: 4%

In the respective Examples and Comparative Examples, the binders (second binders) used in the positive electrode layer and the solid electrolyte layer, and the binders (first binders) used in the insulating layers, were those listed in Table 1. Further, the temperatures of the hot pressing (pressing temperatures) in the respective Examples and Comparative Examples were those listed in Table 1.

The reaction force of the binder at the hot pressing temperature, the reaction force at 120° C., the ratio (reaction force ratio) of the reaction force of the binder (first binder) used in the insulating layers with respect to the reaction force of the binder (second binder) used in the positive electrode layer and the solid electrolyte layer at the temperature of the hot pressing, and the filling rate of the insulating layer after the hot pressing are shown in Table 1.

TABLE 1

| | | positive electrode layer, | | | | | | | | |
|---|---|---|---|---|---|---|---|---|---|---|
| | | solid electrolyte layer | | | insulating layer | | | | | filling |
| | | | reaction force | | | reaction force | | | | rate (%) |
| | | | (N/mm²) | | | (N/mm²) | | reaction | pressing | of |
| | | | pressing | | | pressing | | force | temperature | insulating |
| | | binder | temperature | 120° C. | binder | temperature | 120° C. | ratio | (° C.) | layer |
| examples | 1 | SBR | 0.25 | 0.21 | SEBS | 1.27 | 1.21 | 5.1 | 110 | 75 |
| | 2 | | 0.11 | | | 1.11 | | 10.1 | 140 | 75 |
| | 3 | | 0.05 | | | 0.76 | | 15.2 | 170 | 75 |
| | 4 | | 0.25 | | | 1.27 | | 5.1 | 110 | 70 |
| | 5 | | 0.25 | | | 1.27 | | 5.1 | 110 | 80 |
| | 6 | | 0.05 | | | 0.76 | | 15.2 | 170 | 70 |
| | 7 | | 0.05 | | | 0.76 | | 15.2 | 170 | 80 |
| | 8 | | 0.05 | | | 0.76 | | 15.2 | 170 | 85 |
| | 9 | | 0.05 | | | 0.76 | | 15.2 | 170 | 65 |
| comparative | 1 | SEBS | 1.27 | 1.21 | SEBS | 1.27 | 1.21 | 1.0 | 110 | 80 |
| examples | 2 | | 1.11 | | | 1.11 | | 1.0 | 140 | 75 |
| | 3 | | 0.76 | | | 0.76 | | 1.0 | 170 | 70 |
| | 4 | SBR | 0.25 | 0.21 | SBR | 0.25 | 0.21 | 1.0 | 110 | 80 |
| | 5 | | 0.11 | | | 0.11 | | 1.0 | 140 | 75 |
| | 6 | | 0.05 | | | 0.05 | | 1.0 | 170 | 70 |

### (Evaluation Test)

For each of the solid-state batteries obtained in the Examples and Comparative Examples, the operation of passing the solid-state battery through a pair of rollers for hot pressing and carrying out hot pressing at the pressing temperature listed in Table 1 was carried out on a total of five solid-state batteries. Thereafter, the surfaces of the rollers for hot pressing were observed, and the seepage amount (mm) of the binders was determined by the following method.

Portions of seepage, which were at five or more places on one circumference of the roller, were photographed in a state in which a ruler was made to contact the roller, and the seepage distances were measured in the image. The average value of five points was used as the seepage amount.

After the evaluation test, evaluation was carried out on the basis of the following standards.
A: there was a small seepage amount, and neither peeling of the positive electrode nor sticking of the insulating layers occurred
B: as compared with A, the seepage amount was the same, and neither peeling of the positive electrode nor sticking of the insulating layers occurred, but there was a tendency for slight short-circuiting at the battery
C: there was a large amount of seepage, and sticking of the insulating layers occurred or peeling of the positive electrode occurred

The results are shown in Table 2. The reasons for the defects are listed in Table 2.

TABLE 2

| | | evaluation | | |
|---|---|---|---|---|
| | | seepage | | |
| | | amount | | |
| | | (mm) | results | reason for defect |
| examples | 1 | 0.03 | A | |
| | 2 | 0.05 | A | |
| | 3 | 0.08 | A | |
| | 4 | 0.00 | A | |
| | 5 | 0.05 | A | |
| | 6 | 0.03 | A | |
| | 7 | 0.08 | A | |
| | 8 | 0.10 | B | (*however, tearing occurred at |
| | | | | end portion) |
| | 9 | 0.00 | B | (*however, peeling of insulating |
| | | | | layer at slit occurred) |
| comparative | 1 | 0.03 | C | peeling of positive electrode occurred |
| examples | 2 | 0.05 | C | peeling of positive electrode occurred |
| | 3 | 0.08 | C | peeling of positive electrode occurred |
| | 4 | 0.43 | C | sticking of insulating layer to press |
| | | | | roller occurred |
| | 5 | 0.65 | C | sticking of insulating layer to press |
| | | | | roller occurred |
| | 6 | 1.58 | C | sticking of insulating layer to press |
| | | | | roller occurred |

As shown in Table 1, it can be understood that, in the Examples in which the first binder whose reaction force at the hot pressing temperature was in the above-described range was contained in the insulating layers, and in which the second binder whose reaction force at the hot pressing temperature was in the above-described range was contained in the positive electrode layer and the solid electrolyte layer, the amount of seepage of the binders was low as compared with the Comparative Examples that did not satisfy this condition. Further, in Examples 8 and 9, the seepage amount was low, and neither peeling of the positive electrode nor sticking of the insulating layer occurred. However, in Example 8, tearing occurred at the end portion of the insulating layer, and, in Example 9, peeling of the insulating layer occurred at a slit.

### EXPLANATION OF REFERENCE NUMERALS

2 collector, 4 negative electrode layer, 6 solid electrolyte layer, 8 positive electrode layer, 10, 10B, insulating layer, 20 solid-state battery

What is claimed is:

1. A method of manufacturing a solid-state battery, comprising:
preparing a solid-state battery having an electrode body that has a positive electrode layer, a solid electrolyte layer, a negative electrode layer and an insulating layer and in which the positive electrode layer, the solid electrolyte layer and the negative electrode layer are layered in that order, and the insulating layer is disposed so as to contact a surface, which is at the positive electrode layer side of the solid electrolyte layer in a layering direction, and so as to contact side surfaces of the positive electrode layer in a direction orthogonal to the layering direction and a longitudinal direction of the electrode body; and
hot pressing the solid-state battery from both sides in the layering direction,
wherein the insulating layer contains a first binder having a reaction force at a temperature of the hot pressing of from 0.60 N/mm² to 1.50 N/mm², and
the positive electrode layer and the solid electrolyte layer contain a second binder having a reaction force at the temperature of the hot pressing of from 0.01 N/mm² to 0.40 N/mm².

2. The method of manufacturing a solid-state battery of claim 1, wherein the reaction force of the first binder at the temperature of the hot pressing is 5 or more times the reaction force of the second binder at the temperature of the hot pressing.

3. The method of manufacturing a solid-state battery of claim 1, wherein the first binder is a block copolymer of styrene-ethylene/butylene-styrene, and the second binder is styrene-butadiene rubber.

4. The method of manufacturing a solid-state battery of claim 1, wherein a filling rate of the insulating layer after the hot pressing is from 70% to 80%.

5. A solid-state battery comprising:
an electrode body having a positive electrode layer, a solid electrolyte layer, a negative electrode layer and an insulating layer,
wherein:
the positive electrode layer, the solid electrolyte layer and the negative electrode layer are layered in that order,
the insulating layer is disposed so as to contact a surface, which is at the positive electrode layer side of the solid electrolyte layer in a layering direction, and so as to contact side surfaces of the positive electrode layer in a direction orthogonal to the layering direction and a longitudinal direction of the electrode body,
the insulating layer contains a first binder having a reaction force at 120° C. of from 1.00 N/mm² to 1.50 N/mm², and
the positive electrode layer and the solid electrolyte layer contain a second binder having a reaction force at 120° C. of from 0.01 N/mm² to 0.40 N/mm².
